(19) United States
(12) Patent Application Publication
(10) Pub. No.: US 2025/0244467 A1
(43) Pub. Date: Jul. 31, 2025

(54) RADAR TAGS AND INFRARED TAGS

(71) Applicant: OXFORD UNIVERSITY INNOVATION LIMITED, Oxford (GB)

(72) Inventors: Tonya Allen LANDER, Oxford (Oxfordshire) (GB); Christopher John STEVENS, Oxford (Oxfordshire) (GB); Rana Pratap YADAV, Oxford (Oxfordshire) (GB)

(21) Appl. No.: 18/855,649

(22) PCT Filed: Apr. 6, 2023
(86) PCT No.: PCT/GB2023/050934

§ 371 Date: Oct. 10, 2024

(30) Foreign Application Priority Data
Apr. 11, 2022 (GB) 2205296.3

(51) Int. Cl. G01S 13/75; G05D 1/242; G05D 1/689; G05D 105/80; G05D 109/20

(52) U.S. Cl. CPC G01S 13/75; G05D 1/242; G05D 1/689; G05D 2105/80; G05D 2109/20

(57) ABSTRACT

A method for controlling an aerial vehicle, UAV, includes causing the UAV to adjust its orientation; monitoring a change in radio signal received at the UAV with the change in orientation; determining a translational movement of the UAV based on the monitored change; and causing translational movement of the UAV based on the determination.

This invention relates to tracking or locating objects using a tag or transponder.

### BACKGROUND

There are various applications that involve tracking or locating an object. In some cases a tag may be attached to the object to be tracked or located. The tag may be arranged to emit a signal, such as a radio frequency (RF) signal that can be used to track or locate the tag, and hence track or locate the object.

Tags for use in some applications may be subject to constraints, such as a size range of the tag or radiation properties of the tag.

An example application of such a tag is to study the behaviour of a pollinator (e.g. a pollinator insect, such as a bumblebee). Tracking the movement of pollinators is useful in the study of pollinator behaviour, plant-pollinator interactions, and how behaviour and ecological interactions are impacted by spatial land-use patterns and land management. These data can then be used as a foundation for modelling the necessary quantity, spatial pattern and temporal presence of floral resources in agricultural systems to maintain healthy wild pollinator communities. In this case, the tag would be attached to, and carried by, the pollinator. The size and weight of the tag may be constrained in order to reduce changes in the pollinator's behaviour due to the presence of the tag. Pollinators may move over a range of kilometres; tracking over these distances may be challenging. Similar methods and considerations apply to the study of pests, such as locusts. Studies concerning the tracking of other insects, such as beetles, and birds involve similar considerations.

Tracking tags may also find application in other situations such as asset or stock management (e.g. to track the movement of stock items, or tracking assets, such as on a building site or in a hospital) or sport (e.g. to track the location of a ball).

### BRIEF SUMMARY OF THE DISCLOSURE

Aspects and embodiments are set out in the appended claims.

### BRIEF DESCRIPTION OF THE DRAWINGS

Embodiments of the invention are further described hereinafter with reference to the accompanying drawings, in which:

FIG. 1a illustrates an example of a harmonic radar system.

FIG. 1b illustrates a harmonic radar tag.

FIG. 2a shows another harmonic radar system 200.

FIG. 2b shows a block diagram of a receiver according to some examples of the system of FIG. 2a.

FIG. 2c illustrates an approach to determine a distance between a transmitter and a tag.

FIG. 3 shows plots of the power of received signals for systems with different receiver locations.

FIGS. 4a and 4b illustrate a layout of an antenna and an equivalent circuit.

FIG. 4c shows an example of a tag suitable for use with the system of FIG. 2a.

FIG. 5 shows the feed line 450 of FIG. 4c.

FIGS. 6a to 6g show a detailed example of a structure according to the tag of FIG. 4c.

FIG. 7 shows a simulation of the S11 parameter for the tag of FIGS. 6a to 6g.

FIGS. 8a to 8f show radiation patterns for the tag of FIGS. 6a to 6g.

FIG. 8g shows the arrangement of components in the system for determining the radiation patterns.

FIG. 9 illustrates a method 900 for controlling a UAV.

FIGS. 10a to 10c show an example of a UAV carrying a radar receiver in the vicinity of a tag.

FIGS. 11a to 11k show an example of pitch and roll adjustments of a UAV.

FIGS. 12a to 12c show example paths that may be followed by a UAV.

FIGS. 13a and 13b show examples of a coverage pattern when a UAV performs pitch and roll motions.

FIGS. 14a and 14b show an example of a UAV having a detector with a detection zone that is not symmetrical about a yaw axis of the UAV.

FIG. 15 shows an example of a system that includes a UAV and a tag with a retroreflective element.

FIG. 16 shows a system that includes a UAV and a tag with an infrared light source.

### DETAILED DESCRIPTION

Herein tracking and locating are used interchangeably.

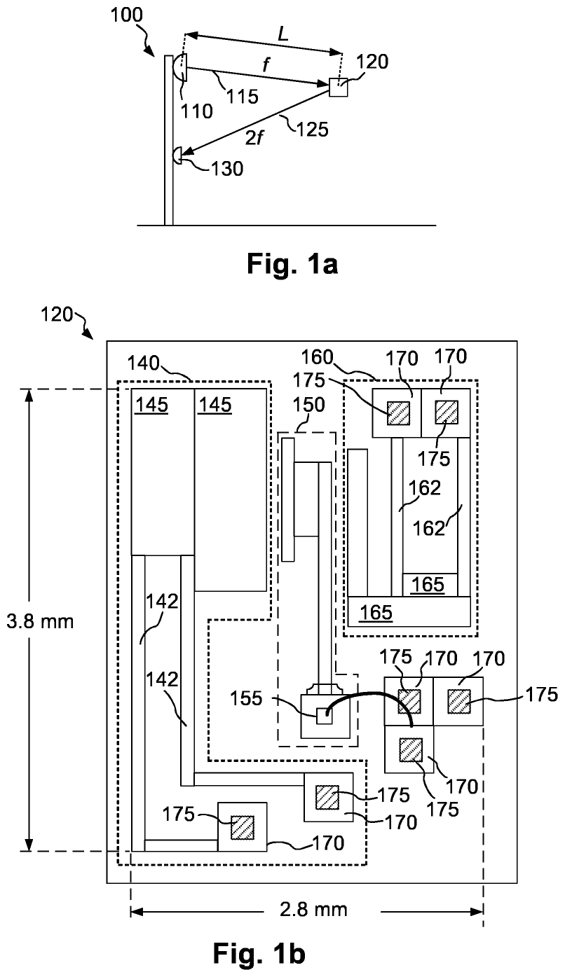

A harmonic radar system may be used for tracking an object. FIG. 1a illustrates an example of a harmonic radar system 100 that includes a radar transmitter 110 to generate an exciting signal of high intensity microwave pulses 115 at a first frequency, f. An object to be tracked may be equipped with a tag 120 arranged to respond to the exciting signal by radiating an excited signal with a frequency that is a harmonic of f (e.g. transmitting microwave pulses at frequency 2f, as shown in FIG. 1a.) A receiver 130 is used to detect the excited signal 125 from the tag 120 and the detected signal 125 may be used to determine a location of the tag 120. For example, the direction from which the signal 125 is received may be used to determine a direction to the tag 120 relative to the receiver 130. Typically, as shown in FIG. 1a, the transmitter 110 and receiver 130 may be co-located (e.g. in a station housing both transmitter 110 and receiver 130). Arrangements having the transmitter and receiver located together may be referred to as a monostatic harmonic radar system 100.

In the system of FIG. 1a, the tag is passive; and so does not require a local power source. This may allow for the provision of a tag with a small size and low weight, for example, a tag may have a side length between 2 mm and 3 mm, with a thickness between 0.5 mm and 1 mm (e.g. the tag may have a size around 2.7 mm×2.7 mm×0.76 mm), and weight between 10 mg and 20 mg (e.g. around 15 mg). Further, small size and weight may be achieved without compromising the tag's efficiency and radiation pattern. Because the exciting signal 115 and excited signal 125 are at different frequencies, the exciting signal 115 does not cause noise in the detection of the excited signal 125, simplifying detection of the harmonic signal 125, even when the harmonic signal 125 has a relatively low power.

A harmonic tag may include a receiver antenna, a mixing element to generate the second harmonic and a second harmonic transmitting antenna. A Schottky diode may be used as a mixer as these may produce harmonics for low input power while having a capacitance that is low enough for operation at typical radar frequencies.

FIG. 1b illustrates a harmonic radar tag 120 for tracking bees, as described in Tsai, Zuo-Min, et al. “A high-range-accuracy and high-sensitivity harmonic radar using pulse pseudorandom code for bee searching,” IEEE Transactions on Microwave Theory and Techniques, 2013, 61.1 pp. 666-675. This tag 120 uses metamaterial derived antennas. These tags, based on micro-strip implementations of left-handed transmission lines may be formed in a 2.8 mm×3.8 mm area on a 0.76 mm thick substrate, and have a weight of 20 mg. The tag 120 according to Tsai is intended to be carried by a bee, and includes a first antenna 140 for receiving a 9.4 GHz radar signal. The tag 120 also includes a diode 155 acting as a doubler. The diode 155 is included in feed line 150. The tag 120 also includes a second antenna 160 for transmitting a harmonic signal at 18.8 GHz. The tag 120 has a complete back side ground metal that provides shielding for the bee. The tag 120 also includes seven ground pads 170 with respective vias 175 that are connected with the back side ground metal.

The tag 120 of Tsai is small and light enough to be carried by a bee. However, further size and weight reduction may reduce the likelihood, or degree, of any changes in the bee's behaviour due to the presence of the tag.

The harmonic tag receives power delivered from the radar transmitter according to the Friis formula

$$Pr = \frac{4 η {P}_{t}^{2} {A}_{TX}^{2} {A}_{r}^{2} {A}_{r 2} {A}_{RX}}{{L}^{4} {λ}^{4}}$$

where Pᵣ and Pₜ are the detected returning second harmonic and transmitted first harmonic powers, A_{TX} an A_{RX} are the transmitter and receiver effective apertures, Aᵣ and Aᵣ₂ are the tag first harmonic and second harmonic effective apertures, A is the first harmonic wavelength and L is the range to the tag. η is the ratio of second harmonic power generated by the tag to the arriving first harmonic power. In general, this is not a linear response, with second harmonic power scaling as the square of first harmonic power approximately P_{2f}=ηP_{1f}² where P_{1f} is the first harmonic power at the mixing element in the tag and Per the second harmonic power generated. With a monostatic radar, signals travel to the target and their reflection returns to the radar along same path of length L resulting in an overall path loss scaling as 1/L⁴ according to the Friis equation.

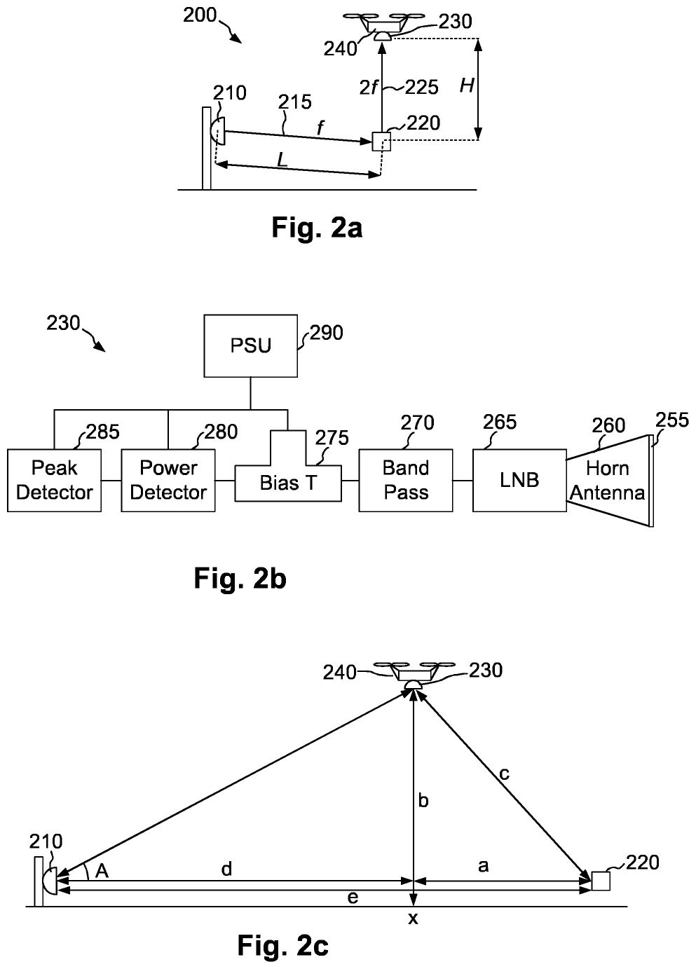

FIG. 2a shows a harmonic radar system 200. The system 200 may allow for tracking a tag 220 over a larger area than the system 100 of FIG. 1a (for similar transmission power and detector sensitivity).

The harmonic radar system 200 includes a radar transmitter 210 to generate an exciting signal 215 of high intensity microwave pulses at a first frequency, f. An object to be tracked may be equipped with a tag 220 arranged to respond to the exciting signal by radiating an excited signal 225 with a frequency that is a harmonic of f (e.g. transmitting microwave pulses at frequency 2f, as shown in FIG. 2a.) A receiver 230 is used to detect the excited signal 225 from the tag 220. The receiver 230 is mounted on an unmanned aerial vehicle (UAV) 240. The UAV 240 may be controlled based on the detected signal 225. For example, the UAV 240 may be controlled to remain directly above the tag 220. In some examples the UAV 240 may be controlled to remain at a constant height. The location of the tag 220 may be detected based on signal 225, the location of the UAV 240, or a combination of these. For example, where the UAV 240 is controlled to fly above the tag 220 the longitude and latitude of the tag 220 may be approximated as the longitude and latitude of the UAV 240. That is, the UAV 240 may be assumed to be directly above the tag 220. A location of the UAV 240 may be determined using GPS, dead reckoning, or any other positioning method. In some examples, a direction to the tag 220 from the receiver 230 may be determined based on the received signal 225, the approximate location of the tag may then be determined from the position of the drone and the direction to the tag. In some examples, the location of the tag may be within 3 meters of the approximate determined location. The accuracy of the location may depend on pulse length of the radar and a beamwidth of the receiver. In some examples the receiver 230 may have a beamwidth such that signals from within a pattern at ground level are received by the receiver 230. The pattern may be a circle of 3 m at ground level when the receiver 230 is 10 m above the ground. In some examples, refinement of a tag 220 location may be achieved by scanning the receiver 230 (i.e. moving the pattern across the ground) such that variation of received signal with movement of the pattern may be used to provide a more accurate location for the tag 220, assuming that movement of the tag 220 during the scanning is negligible. The scanning may include moving the receiver 230, and/or adjusting one or more of pitch or roll of the receiver 230. Adjusting the height of the receiver may also adjust the accuracy of the determined tag 220 location. The arrangement of FIG. 2a may be referred to as a bistatic radar system (or a bistatic harmonic radar system), as the transmitter and receiver are not co-located.

The distance between the tag 220 and receiver 230 will typically be shorter in the arrangement of FIG. 2a than in the arrangement of FIG. 1a. In particular, the second harmonic 225 travels a shorter distance to the receiver 230, and hence is stronger, for any given downrange distance L when the altitude H of the UAV 240 above the tag 220 is less than the distance between the transmitter 210 and tag 220, according to:

$$Pr = \frac{4 η {P}_{t}^{2} {A}_{TX}^{2} {A}_{r}^{2} {A}_{r 2} {A}_{RX}}{{L}^{2} {H}^{2} {λ}^{4}}$$

In the arrangement of FIG. 2a, the received power increases by a factor or L²/H² compared with the arrangement of FIG. 1a. For a range of 100 m and altitude of 10 m this may lead to a signal to noise ratio around 100 times higher than monostatic arrangement of FIG. 1a.

In some examples of the system of FIG. 2a, the radar transmitter 210 may be an X-band pulsed magnetron radar, and may be relatively inexpensive and portable. In some examples, the radar transmitter 210 may operate at the 9.41 GHz frequency, such that the harmonic tag 220 would emit 18.82 GHz signals. The radar transmitter 210 may have a 40 MHz bandwidth. According to an example the pulsed magnetron radar may be rated for 3.0 kW pulsed output power in a frequency range of 9.21 GHz to 9.61 GHz. The transmitting antenna may have a gain of 20 dBi with vertical and horizontal half beam-width of 25° and 7.2°, respectively.

Where the radar transmitter 210 produces transmissions with a significant second harmonic content, the transmitted second harmonic may interfere with detection of the second harmonic signal from the tag 220. In this case, the emission of the second harmonic may be reduced. For example, a frequency selective surface that passes the fundamental frequency but not the harmonic may be mounted across the radar horn, a stepped impedance filter may be added to the antenna waveguide feed to pass the fundamental frequency and block the second harmonic, electromagnetic shielding may be added to prevent harmonics escaping via the power and data systems. Any combination of these measures may be used.

FIG. 2b shows a block diagram of a receiver 230 according to some examples of the system 200 of FIG. 2a. The receiver may be designed to detect the radar's second harmonic (e.g. at 18.82 GHz) generated by a tag excited at the first harmonic (e.g. 9.41 GHZ) from the Radar transmitter.

FIG. 2b shows an example receiver 230 suitable for use in the system 200 of FIG. 2a. The receiver 230 includes a frequency selective surface 255 to aid in first harmonic rejection. The receiver 230 may also include a horn antenna 260. In some examples, the horn antenna 260 may have a gain of 20 dB and return loss of −22 dB. The horn antenna 260 may be designed to collect signals from 3.0 m footprint when the UAV is operating at 10 m altitude. As the receiver 230 is to be carried by a UAV, the horn antenna may be constructed of a lightweight material. The antenna structure may be 3D printed with Acrylonitrile butadiene styrene (ABS) material and metallised with conductive copper paint. The receiver 230 may include a Low Noise Block (LNB) 265 receiver to down-convert the second harmonic to a lower frequency (e.g. 1.42 GHZ). The receiver 230 may include a narrowband filter 270 to select only the harmonics generated by the tag. The receiver 230 may include a bias T 275 to provide a route for DC power injection (e.g. from a power supply unit 290, such as a 12-24 V DC PSU) to the LNB 260. A power detector 280 may complete the demodulation of the radar pulses. A peak detector 285 (e.g. a negative peak detector or positive peak detector, depending on the polarity of the power detector 280) may provide a low frequency output for use with sampling analogue-to-digital conversion or a micro-controller system.

In the case of a transmitter that emits pulses of a particular duration (e.g. 300 ns long), this duration will be reflected in the duration of harmonic pulses emitted by the tag in response to the signal from the transmitter. If the transmitter transmits a signal at 9.405 GHz, the second harmonic emitted by the tag will be at 18.81 GHz. Where the LNB has a local oscillator frequency of 17.4 GHz, the second harmonic signal will be shifted to 1.39 GHz at the output of the LNB. In this case, the narrowband filter may be a ceramic bandpass filter with a passband from 1384 MHz to 1400 MHMz. The bandwidth of the bandpass filter and the frequency stability may be factors in the long range performance of the tracking system.

FIG. 2c illustrates an example of approximating the distance between the transmitter 210 and the tag 220 based on time delays in the received signals. In the arrangement of FIG. 2c the height of the tag 220 and transmitter 210 may be neglected (i.e. approximating the height of the tag 220 and transmitter 210 as being at ground level). Alternative approximations could be used (e.g. assuming that the tag 220 is at the same height as the transmitter 210, where the height of the transmitter 210 is known). The appropriate approximation may depend on the application or the nature of the object to be tracked. For example, certain insects may be expected to fly close to the ground, such that assuming the tag 220 is at ground level is a good approximation. Similarly, where equipment or inventory items are to be tracked they are likely to be at ground level. In some examples topographical information (such as elevation of the ground as a function of location in the area of interest) may be included in the distance determination.

A distance between the tag 220 and transmitter 210 is denoted e in FIG. 2c. A distance between the receiver 230 and the tag 220 is denoted c. A time delay between the transmission of a signal by the transmitter and the reception of a resonant signal by the receiver 230 may be used to determine the distance etc. The point x indicates a point on the ground directly beneath the receiver 230. Where it can be assumed that the transmitter 210, tag 220 and receiver 230 are in the same plane perpendicular to the ground, the point x lies on the line between the transmitter 210 and the tag 220. The distance between the transmitter 210 and point x is denoted d, and may be determined based on the known positions (or known relative positions) of the transmitter 210 and UAV 240 (e.g. using GPS data or dead reckoning from the UAV 240). A distance between the tag 220 and point x is denoted a. In this arrangement, a+c=e+c−d.

In a right-angle triangle,

$$u = P \frac{P - 2 v}{2 ( P - b )} ,$$

where P is the perimeter of the triangle and u and v are the lengths of the two shortest sides. Applying this to the right-angled triangle having the tag 220, receiver 230 and point x at its vertices, P=a+b+c, u=a and v=b and so

$$a = ( a + b + c ) \frac{a + b + c - 2 b}{2 ( a + c )} .$$

From the above, a+c is known, as is b, and so a can be found. The distance e between the transmitter 210 and tag 220 can then be found from e=a+d.

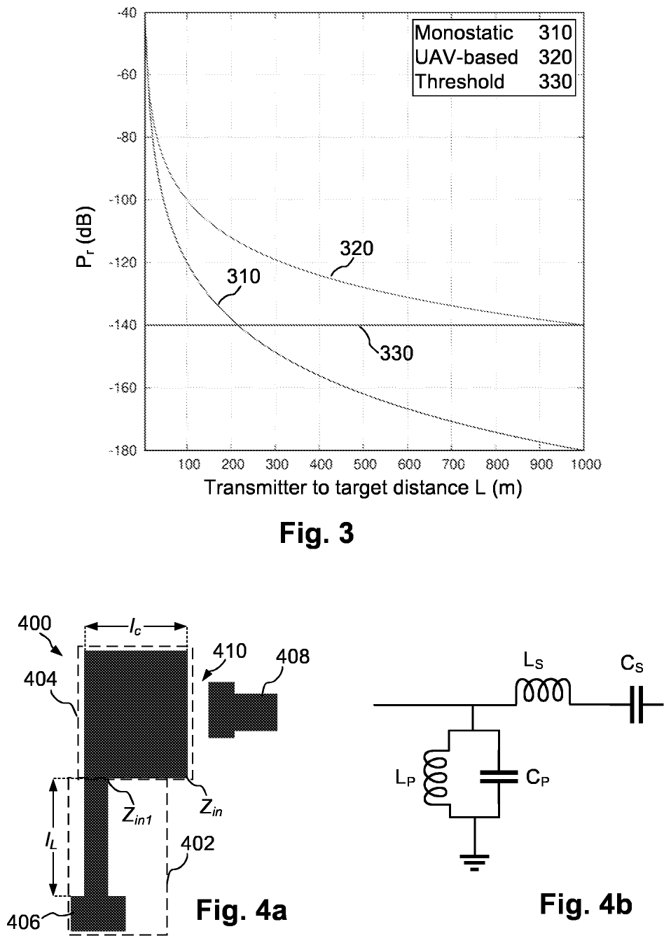

FIG. 3 shows plots of the power of received signals for two identical systems differing only in the receiver location. Plot 310 shows the power of the harmonic signal received at the receiver in a monostatic system, as shown in FIG. 1a. Plot 320 shows the power of the harmonic signal received at a receiver located above the tag, as shown in FIG. 2a. For downrange distances, L, greater than the UAV 240 altitude, the harmonic signal enhancement is very clear. While the tag 220 is still being excited by the same power in each case, the UAV-based radar (shown by line 320) can expect enhancement in signal resulting in an increase in the maximum useful range of the system as denoted by the threshold minimum detectable power (line 330) of −140 dBW. In FIG. 3 the monostatic system (line 310) has a useful range of 200 m whilst the system of FIG. 2a (line 320) may operate up to 1 km.

In typical radar tags, such as the tag described in Tsai, the first harmonic 115 is received and the second harmonic 125 returned horizontally so that a tag 120 is to both receive and radiate strongly in the horizontal plane (i.e. in a plane of the substrate). This is appropriate for a monostatic system, where the transmitter 110 and receiver 130 are ground-based. For the bistatic harmonic radar arrangement of FIG. 2a, having an airborne receiver 230 and ground based transmitter 210, the effectiveness of the system 200 is improved when the tag 220 receives strongly in the horizontal direction (e.g. in the plane of the tag 220) at the first harmonic 215 while transmitting with a high gain towards the zenith (e.g. perpendicular to a plane of the tag 220). Radar tags, such as the tag described by Tsai, may have a null in transmission in the direction perpendicular to the tag substrate.

A tag 220 for use in the arrangement of FIG. 2a may be arranged, in use, to receive with a high (or maximal) gain in a horizontal plane and arranged to transmit with high (or maximal) gain in a direction within 45 degrees of vertical. In some examples the maximum gain for transmission may be in a direction within 20 degrees of vertical. In some examples the maximum gain for transmission may be in a direction within 10 degrees of vertical. In some examples the maximum gain for transmission may be essentially vertical. The tag 220 may be formed on a planar substrate, the transmit antenna, receive antenna, or both may be planar and lie in or on the plane of the substrate.

The transmit antenna may be arranged to have a maximum gain in a direction within 45 degrees of a direction perpendicular to the first plane. The first plane may be defined as a plane of the receiving antenna, a plane of the transmitting antenna, or a plane of the substrate.

A system according to the arrangement of FIG. 2a includes a passive resonator tag 220 to receive radio waves 215 at a first frequency, f, and emit radio waves 225 at a second frequency, the second frequency being a harmonic of the first frequency, e.g. 2f. The system also includes an unmanned aerial vehicle, UAV, 240, where a radio receiver 230 is to be carried by the UAV 240. The radio receiver is to receive radio waves 225 at the second frequency emitted by the passive resonator tag 220. The passive resonator tag 220 comprises a transmit antenna lying in a first plane, and the transmit antenna is arranged to have a maximum gain in a direction within 45 degrees of a direction perpendicular to the first plane. In some examples, the first plane may be a plane of a substrate on which the transmit antenna is formed.

The system of FIG. 2a may include a tag detector to determine a direction of the tag from the UAV based on the radio waves received by the radio receiver. The tag detector may be carried by the UAV, or may be located elsewhere, such as at a ground station in communication with the UAV. The tag detector may receive information indicative of a change in radio signal received at the radio receiver of the UAV, the change associated with a change in receive direction (e.g. due to motion of the radio receiver or motion of a region from which the radio receiver may receive signals). The tag detector may determine the direction of the tag relative to the UAV based on the received information. The system may also include a controller to control the UAV to move based on the determined direction. The controller may be carried by the UAV or may be located elsewhere, such as at a ground station in communication with the UAV. The tag detector may be included in the controller.

In order to determine a direction to a source of a radio signal from a radio receiver 230, the radio receiver 230 may include mechanically moving parts, such as a gimbal, e.g. to change the orientation of the antenna relative to the UAV. The received signal level will peak when the antenna is pointing in the direction of the source, where the antenna can be considered to point in its direction of maximum gain.

In some examples, the controller may be arranged to cause the UAV 240 to change its orientation, such that a direction of maximum gain of the radio receiver 230 changes. The tag detector may determine the direction to the tag 220 based on a variation in the received radio waves with orientation of the UAV 240. In this example, the direction to the tag 220 may be determined without relative movement between the UAV 240 and the radio receiver 230, or between the UAV 240 and an antenna of the radio receiver. A gimbal or other arrangement for moving the receiver 230 relative to the UAV may be omitted. Accordingly, complexity and weight of the radio receiver 230 mount may be reduced.

In some examples according to FIG. 2a, the controller may control the UAV to move toward a point above the tag.

In some examples the tag may be attached to, and carried by, (or suitable for attachment to and suitable to be carried by) a moving target (e.g. a small moving target), an insect, a bee, a beetle, a locust, or a bird.

In an example, a passive transponder (e.g. suitable for use in a tag in the system of FIG. 2a) includes a metamaterial receive antenna to receive a signal at a first frequency; a metamaterial transmit antenna to transmit a signal at a second frequency, the second frequency being a harmonic of the first frequency. The transmit antenna lies in a first plane, and the transmit antenna has a maximum gain in a direction within 45 degrees of a direction perpendicular to the first plane. This arrangement may provide improved performance when a receiver is located in a direction approximately perpendicular to a plane of the transmit antenna. The plane of the transmit antenna may be the plane of a substrate that carries the transmit antenna. The receive antenna may lie in the same plane as the transmit antenna.

The passive transponder may include a feed line coupled to each of the receive antenna and the transmit antenna, the feed line may include a mixer to generate the signal at the second frequency, and the feed line may be conductively coupled to the transmit antenna.

A passive transponder (e.g. for use in the tag in the system of FIG. 2a) includes a metamaterial receive antenna to receive a signal at a first frequency; a metamaterial transmit antenna to transmit a signal at a second frequency, the second frequency being a harmonic of the first frequency. The transmit antenna lies in a first plane, and a feed line is coupled to each of the receive antenna and the transmit antenna. The feed line includes a mixer to generate the signal at the second frequency, wherein the feed line is conductively coupled to the transmit antenna. This arrangement may provide improved out-of-the-plane of transmission.

The feed line may include a first stepped edge such that, at the second frequency, capacitive coupling between the feed line and transmit antenna dominates conductive coupling between the feed line and transmit antenna.

The feed line may include a second stepped edge, such that the feedline acts as a bandpass filter centred at the second frequency. This can allow the transponder to operate in a smaller frequency range, potentially allowing an increased number of other transponders operating at different frequencies within a particular frequency range.

The passive transponder may include a ground pad connected to a ground plane, wherein the ground pad is conductively connected to the receive antenna and the transmit antenna. In some examples the ground pad may also be connected to a mixer of the feed line. In some examples the tag may include a single ground pad. Reducing a number of ground pads may reduce a footprint of the tag. Further, reducing the number of ground pads may also include reducing a number of vias. Reducing the number of vias may simplify construction of the tag, and may reduce vertical polarisation of the signal emitted by the tag.

The receive antenna may include two meta-atoms, each meta-atom may include a plate portion connected to a respective leg portion. The transmit antenna may comprise two meta-atoms, each meta-atom may include a plate portion connected to a respective leg portion, wherein each plate portion is wider than the respective leg portion, and the leg portions extend in the same direction away from the respective plate portions. In particular, the leg portions of the transmit antenna may extend in the same direction as the leg portions of the receive antenna.

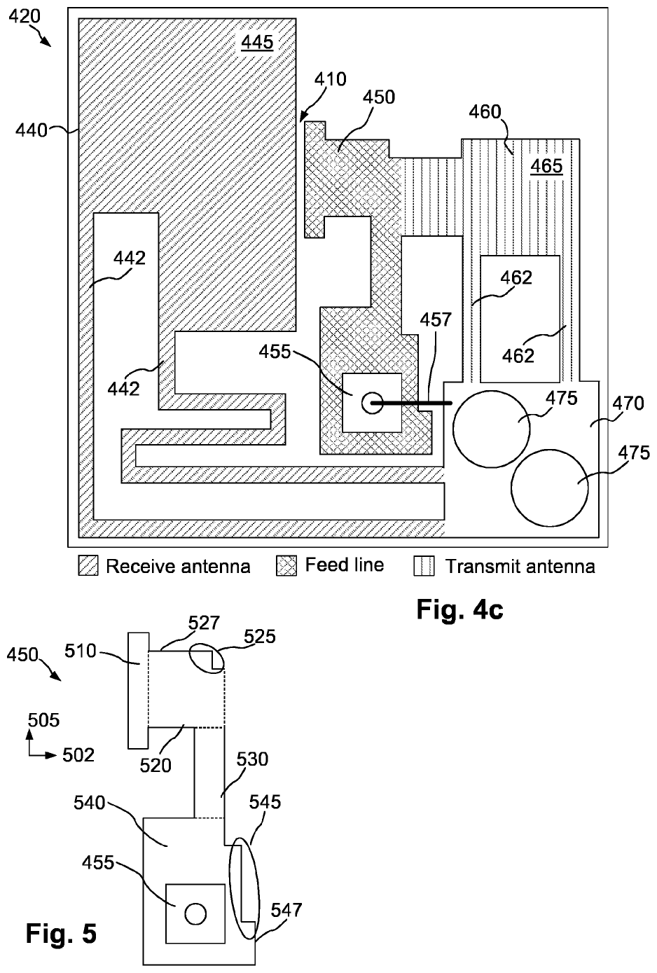

FIG. 4a illustrates a layout of an antenna 400. An equivalent circuit is shown in FIG. 4b. FIG. 4a shows metal structures in the top layer of the structure. The back side of the structure may be a continuous ground plane. The antenna forms an LC circuit with two main sections; an inductor (L-Strip or leg portion) 402 and a capacitor (C-Patch or plate portion) 404. The L-Strip 402 includes or is connected to a ground pad 406, which is connected to ground (e.g. by a via). The C-Patch 404 is separated from a feed stub 408 of a feed line by coupling gap 410. In the equivalent circuit the L-Strip 402 size controls Lp and the C-Patch 404 controls the value of Cp. The other two components Ls and Cs are the series inductance for currents travelling mostly left to right across the C-Patch 404 and the capacitance coupling it to the feed stub 408.

In some examples of tags 220 for use in the system of FIG. 2a, the meta-atoms forming the antennas are small; the whole tag may be less than 3 mm across but receive a wavelength of 30 mm, for example. As such, relatively little retardation plays a role in the circuit behaviour and impedance methods may be used in designing the tag 220. The L-Strip 402 microstrip may be modelled as a shorted transmission line presenting a lumped impedance Z₁=jZ_{L} tan(β_{L}l_{L}) to the C-Patch 404 where β_{L} is this microstrip's propagation coefficient and Z_{L}=jωL/(1−ω²LC). Here, the effective impedance of the L-patch and C-Patch are Z_{L} and Z_{C} respectively and their lengths are written as l_{L} and l_{C} as shown in FIG. 4a. The impedances may be referred to the join between the L-Strip 402 and the C-Patch 404. Varying the length and width of the L-Strip 402, and the size of the C-Patch 404 allows tuning of the antenna by adjusting the shunt resonant frequency ωₛ=(LₚCₚ)⁻¹. For any particular frequency there are a range of possible values for Lₗ and L_{c} that can satisfy the requirement for a resonance at the intended operating frequency. Software, such as CST microwave studio, may be used to simulate, evaluate and optimise the sizes of L-Strip 402 and C-Patch 404 to maintain the resonance at the operating frequency whilst maintaining high radiative efficiency when driving the input to the transmit antenna via the coupling gap 410 (Cs). The overall tag footprint may be reduced by wrapping the L-Strip 402 sections into a smaller area of the substrate. The tag may include two L-Strip 402 sections for each of the two antennas in the tag 400.

FIG. 4c shows an example of a tag 420 suitable for use with the system of FIG. 2a. FIG. 4c shows top metallisation, which may be formed on a substrate. The substrate may have a continuous conducting ground plane on the bottom (or back) side. The ground plane may contribute to the waveguide behaviour and to shielding the object being tracked.

The tag 420 includes a receive antenna 440, feed line 450 and transmit antenna 460. In some examples, the receive antenna 440 may be suitable for receiving 9.4 GHz radar pulses. The transmit antenna 460 may be suitable for emitting radar pulses at 18.8 GHz. The antennas 440, 460 may be meta-atom antennas similar to the antenna shown in FIGS. 4a and 4b, including an LC resonant circuit formed from a narrow microstrip supplying the inductive component and a larger, or wider, patch supplying the capacitance. Each of the antennas of FIG. 4c includes two meta-atoms. The footprint of the tag of FIG. 4c has been reduced by wrapping or folding one of the L-Strip sections 442 of the receive antenna 440, such that the L-Strip section 442 meanders and includes more than two straight sections (six straight sections in FIG. 4c). In some examples, effects of adjustments to other portions of the tag may be offset by modifying the meta-atoms of the antennas, e.g. by lengthening the L-Strip or adjusting the dimensions of the C-Patches. Where the L-Strip is lengthened, wrapping or folding the L-Strip may assist in constraining the overall area of the tag.

The tag of FIG. 4c includes a Schottky diode mixer 455 in the feed line 450. The diode 455 is wire bonded to a ground pad 470. The ground pad 470 is connected to ground, e.g. by one or more vias 475 connected to the ground plane on the back side of the substrate. In the example of FIG. 4c the ground pad has two vias 475. An example tag according to FIG. 4c may have a footprint of 2.7 mm×2.7 mm and a substrate thickness of 0.76 mm. The overall tag dimensions may be 2.7 mm×2.7 mm×1.46 mm when the diode and wire bond are included. Tags of this size are suitable for tracking small pollinators, such as bumblebees. The tag is small enough to be mounted on the thorax of a bumblebee between the wings while being clear of the tegulae (points where the wings join the thorax). Accordingly, the tag will not interfere with the flight of the bumblebee.

The current inventors found that improved vertical emission for the second harmonic signal can be achieved by directly driving the harmonic antenna 460 by conductively coupling the feed line 450 and transmit antenna 460. This could also be considered to be including (or integrating) the mixer element (feed line) 450 into the transmit antenna 460 (or vice-versa) and coupling the combination to the receive antenna 440 via the coupling gap 410. Conductively coupling the feed line 450 and transmit antenna 460 helps to achieve a current distribution that is conducive to vertical radiation.

The tag 420 of FIG. 4c includes a common ground pad connected to the receive antenna 440, transmit antenna 460 and the mixer 455. The tag described by Tsai has predominantly vertical polarisation. A tag with more horizontal polarisation may be better suited to radiating power vertically (perpendicular to the surface). The vertical polarisation in the tag of Tsai may be due in part to the relatively high number of vertical vias. The tag 420 of FIG. 4c includes fewer vias than the tag of Tsai. In the particular example of FIG. 4c, there is a single ground pad 470 with two vias 475. Accordingly, the tag 420 of FIG. 4c may have increased horizontal polarisation, and improved vertical radiation of power when compared with the tag of Tsai. Further, reducing the number of vias may simplify a process for manufacturing the tag.

Reducing the number of ground pads may lead to deterioration of the radiation parameter and operating frequency band. These effects may be offset by adjustment of the size, shape and orientation of the meta-atoms of the receive antenna 440 and transmit antenna 460.

FIG. 5 shows the feed line 450 of FIG. 4c. The feed line 450 includes a first stepped section 525. The first stepped section 525 includes a first stepped edge 527 of the feed line 450 that has a stepped profile (e.g. having a series of parallel portions that are displaced relative to each other in a direction perpendicular to the portions). The first stepped edge 527 may run substantially in a first direction 502, e.g. from the transmit antenna 440 to the receive antenna 460.

A first portion 510 of the feed line 450 nearest the transmit antenna 440 may define one side of the coupling gap 410. A second portion 530 of the feed line 450, between the first portion 510 and the transmit antenna 460, may be narrower than the first portion 510 in a second direction 505 perpendicular to the first direction 502. The second portion 620 may include the first stepped section 525. As such the width (measured in the second direction 505) of the second portion 520 may change with position in the first direction 502.

A third portion 530 of the feed line 450 may be connected to the second portion 520 and extend in the second direction 505 from the second portion 520. The third portion 530 may extend away from the first stepped edge 527 of the second portion 520. The third portion 530 may connect with a fourth portion 540 of the feed line 450. The fourth portion 540 may include the mixer 455. The fourth portion 540 may be wider, in the first direction, than the third portion 530. The fourth portion 540 may include a second stepped section 545 having a second stepped edge 547. In some examples, the second stepped edge 547 runs along the second direction 505. In some examples the fourth portion 540 includes 3 straight, un-stepped edges and one stepped edge 547. In some examples the second stepped edge 547 may include two steps. In some examples, a mid-point of the stepped edge 547 is between the steps. The width, in the first direction 502, of the fourth portion 540 may change with position along the second direction 505 due to the steps.

A single feed line 450 connecting the receive antenna 440 and the transmit antenna 460 can lead to significant coupling between the antennas. The first stepped portion 525 may reduce coupling between the receive antenna 440 and the transmit antenna 460, due to reflections from the step. This may increase the energy delivered to the mixer 455. The first stepped portion 525 may lead capacitive coupling to dominate conductive coupling between the feed line and transmit antenna at the second frequency.

The second stepped portion 545 of the feed line 450 may cause the feed line to act as a band pass filter, allowing the tag to have a narrower transmission band. Tags can be arranged with different step sizes such that different tags will have different transmission frequencies. This would allow tags detected at the receiver to be distinguished from each other. Using narrower transmission bands allows for a greater number of tags with distinct transmission frequencies within a given bandwidth. Further, narrowing the transmission antenna bandwidth reduces cross-coupling between the antennas.

The second stepped portion 545 may also have the effect of increasing the electrical length of the feed line 450 (e.g. relative to an un-stepped feed line). The electrical length refers to the phase shift induced by transmission over the feed line 450. As such, the stepped portion 545 may allow for the size of the feed line to be reduced (relative to an un-stepped feed line) while maintaining the desired electrical properties.

The second stepped portion 545 may introduce a phase change in the transmitted signal that can affect the direction of radiation. This can be used when designing the tag to allow for fine-tuning of the transmission direction.

The second stepped portion 545 may be arranged to have a greater effect at the transmitted frequency (e.g. 18.8 GHZ) than at the received frequency (9.4 GHZ). For example, the sizes of the steps may be small compared with the wavelength at 18.8 GHz.

The fourth portion 540 of the feed line 450 gets narrower from bottom to top (e.g. narrower along the first direction 502 as the third portion 530 is approached along the second direction 505). The wider portion introduces capacitive loading on the feed line 540 and effectively reduces the size of the feed line 540 without affecting its electrical length

Examples according to FIG. 4c may have a receive antenna with gain concentrated in the horizontal plane and a transmit antenna that emits most strongly upwards at an angle within 45 degrees of the direction perpendicular to the substrate, e.g. an angle of approximately 25 degrees off the perpendicular to the substrate.

As can be seen in FIG. 1b, the receive antenna 140 and transmit antenna 160 are oriented in opposite directions. The legs 142, or microstrip portions, of the receive antenna 140 extend from the patch sections 145 of the receive antenna 140 downwards in FIG. 1b. In contrast, the legs 162 of the transmit antenna 160 extend from the patch sections 165 of the transmit antenna 160 upwards in FIG. 1b. In comparison, the receive antenna 440 and transmit antenna 460 of FIG. 4c are oriented in the same direction. In particular, the legs 442 of the receive antenna 440 extend from the patch sections 445 of the receive antenna 440 downwards in FIG. 1b. Similarly, the legs 462 of the transmit antenna 460 extend from the patch sections 465 of the transmit antenna 160 downwards in FIG. 4c.

The receive antenna 140 and transmit antenna 160 of FIG. 1b can the thought of as antiparallel, while the receive antenna 440 and transmit antenna 460 of FIG. 4c can the thought of as parallel. The relative orientations of the antennas in FIG. 4c assists in producing vertical transmission. In addition, as the legs 442 and 462 of both transmit 440 and receive 460 antennas extend in essentially the same direction, the legs may connect to the same ground pad 470. This assists in reducing the number of vias in the tag. As noted above, reducing the number of vias assists in providing strong vertical transmission. The receive antenna 440 and the transmit antenna 460 of FIG. 4c may each include two meta-atoms. Each of the meta atoms may include a plate or patch portion and a leg portion that is connected, or contiguous, with the patch portion.

The relative orientation of the antennas may affect the radiation pattern and operating band of the antennas. The sizes of the meta atoms of the antennas may be adjusted to obtain the intended operating band. Steps may be included in the feed line to adjust the radiation pattern of the transmission.

The various features (e.g. steps, meandering legs, etc.) added to the components, such as the antennas and feed line, may be considered to add more complexity to an equivalent circuit of the tag components. The additional complexity increases the reactance of the component. By adding steps, or similar structures, a structure may be produced that is mechanically small but long electrically. That is, due to the discontinuity of the structure, the effect of the structure on a signal is similar to the effect of a much longer pure conductor.

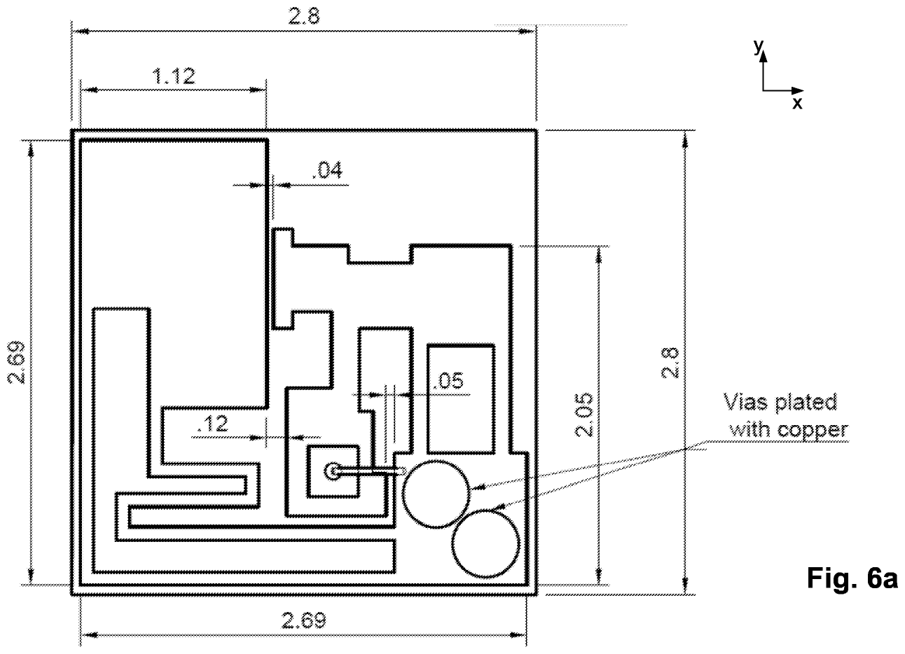

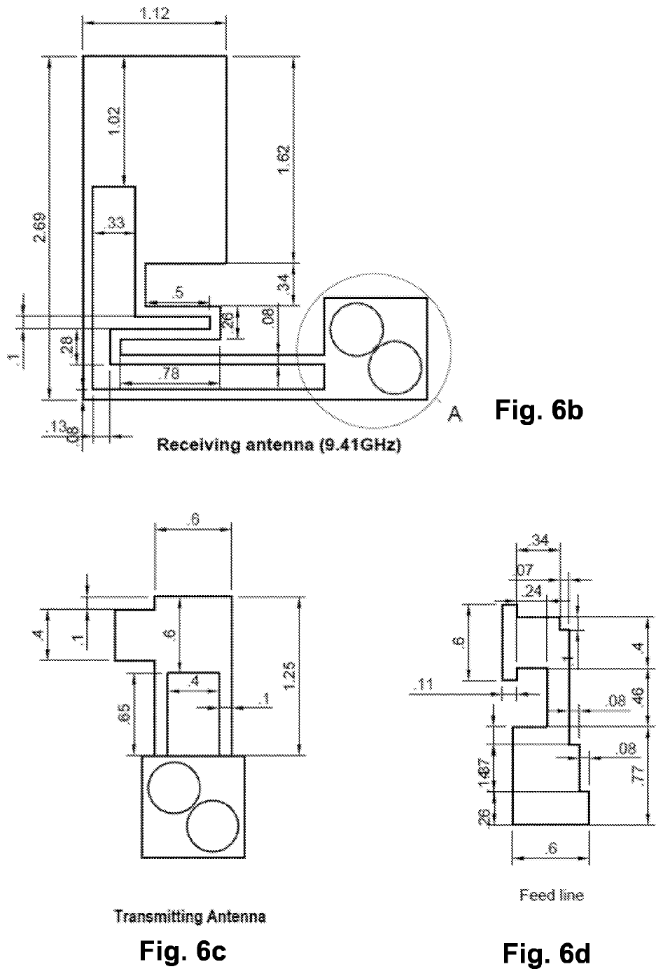

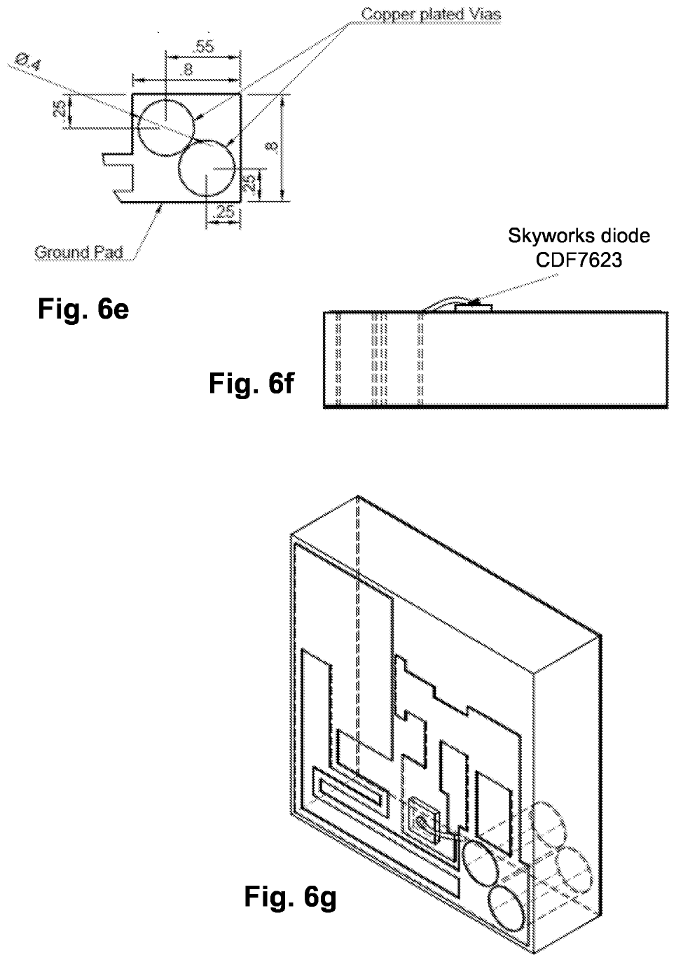

FIGS. 6a to 6g show a detailed example of a structure according to the tag of FIG. 4c. FIG. 6a shows a copper metal pattern of thickness 0.2 mm on a substrate. The substrate has a copper plate of thickness 0.2 mm on its bottom face forming a ground plane. Measurements in FIGS. 6a to 6g indicate lengths in millimetres. FIG. 6a shows the top surface of the tag. As can be seen in FIG. 6a, the tag may have a size of 2.8 mm×2.8 mm (or 2.7 mm×2.7 mm is accurate cutting methods are available). FIG. 6b shows the receiving antenna of FIG. 6a in greater detail. FIG. 6c shows the transmitting antenna of FIG. 6a in greater detail. FIG. 6d shows the feed line of FIG. 6a in greater detail. FIG. 6e shows the ground pad of FIG. 6a in greater detail. FIG. 6f is a side view of the substrate, showing the diode, the connection between the diode and the ground pad, and the vias. FIG. 6g is a perspective view of the tag of FIG. 6a. In the example of FIGS. 6a to 6g, the Schottky diode mixer is a Skyworks CDF7623 that is mounted on the feed line and wirebonded to the ground post. The metal pattern and ground plane are formed using Rogers corporation Ro3003 copper clad laminate with dielectric constant ε=3.0 and low loss (tan δ=10⁻³). The tag may be fabricated using photolithography on resist covered Rogers 3003 laminates. The diode may be bonded using conductive epoxy. The top pad of the diode may be connected to the ground pad using an ultrasonic heated wirebond. The substrate may be cut using laser cutting to separate the tag.

Examples of tags according to FIGS. 6a to 6g have a weight of 15 mg. These tags offer 1.38 dB of gain for the received radar impulses and 2.34 dB of gain in the azimuthal direction for the converted harmonics. According to some examples according to FIGS. 6a to 6g a 3 dB bandwidth of the receive antenna 440 at 9.41 GHz is 5 MHz, and a 3 dB bandwidth of transmit antenna 460 at 18.82 GHz is 67 MHz

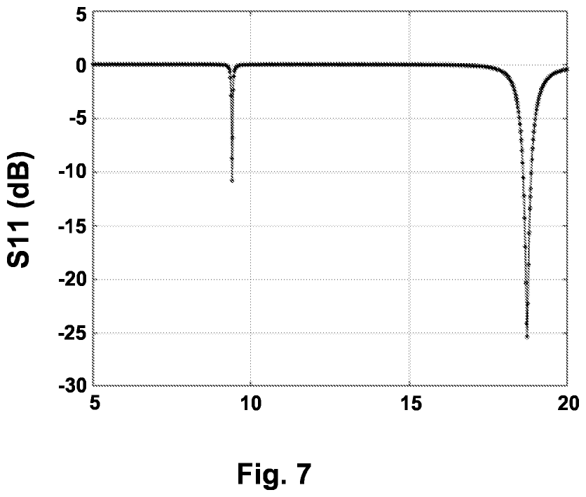

FIG. 7 shows a simulation of the S11 parameter for the tag of FIGS. 6a to 6g. S11 represents how much power is reflected from the antenna. The dual resonance frequencies 9.41 GHz and 18.8 GHz of the tag can be seen in FIG. 7. Further, it can be seen that the tag has a narrow operating band which may improve sensitivity. The 10 dB bandwidth of the tag at 9.41 GHz and 18.82 GHz are calculated as 9.2 MHz and 178 MHz (0.09% and 1.89%) respectively whereas S11 parameter values are −12.25 dB and 26.38 dB respectively. From the simulation it was determined that the majority of the receive antenna's gain is concentrated in the horizontal plane whilst the second harmonic transmit antenna emits the majority of its energy upwards at an angle of approximately 25 degrees from the perpendicular to the substrate. This arrangement is suitable for use with a ground-based transmitter and airborne receiver, with the majority of the harmonic energy directed towards the receiver and not to nearby scattering objects in the environment.

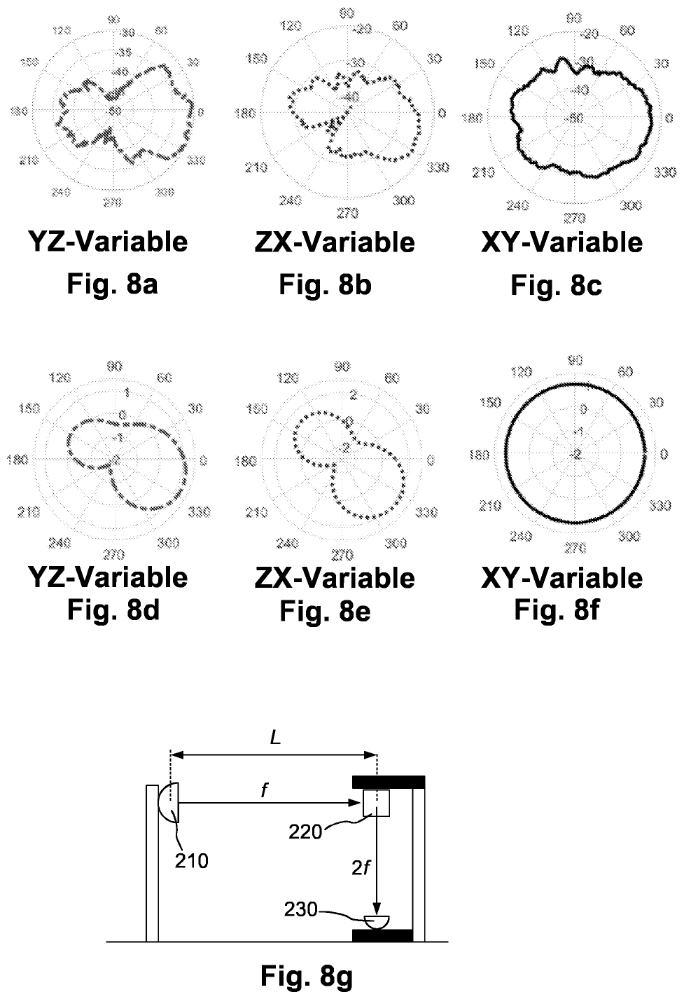

FIGS. 8a to 8f show polar radiation plots for the tag of FIGS. 6a to 6g. FIGS. 8a, 8b and 8c show measured radiation patterns, while FIGS. 8d, 8e and 8f show corresponding simulated patterns. FIG. 8g shows the arrangement of components in the system for determining the radiation patterns. The tag 220 was mounted upside down on a turntable with the receiver 230 vertically below the tag 220. The transmitter 210 was positioned horizontally relative to the tag 220. In each of FIGS. 8a to 8f, 0 degrees corresponds to an arrangement in which the plane of the tag is in the horizontal plane (the XY plane). Each of FIGS. 8a to 8f show the change in signal at the receiver 230 when the tag 220 is rotated in a particular plane (YZ plane in FIGS. 8a and 8d, ZX plane in FIGS. 8b and 8e, XY plane in FIGS. 8c and 8f). The axis x and y are indicted in FIG. 6a, with the z axis perpendicular to the plane of FIG. 6a. As can be seen in FIGS. 8c and 8f, the signal does not change significantly when the tag 220 is rotated in the XY plane. That is, there is high transmission to the receiver 230 when the receiver 230 is vertically above the tag 220 and an edge of the tag 220 faces the transmitter 210, which is the normal in-use condition according to some examples. FIGS. 8a, 8b, 8d and 8e show that when then tag 220 is pitched out of the XY plane. The highest transmission in these figures is when the rotation away from the starting arrangement is close to 0, where the starting position is when the receiver 230 is vertically above the tag 220 (i.e. vertically above the tag 220 in normal use, vertically below the tag in the test arrangement of FIG. 8g) and an edge of the tag 220 faces the transmitter 210. Accordingly, the transmission patterns are efficient for a normal in-use condition in which the tag 220 is edge-on to the transmitter 210 and the receiver 230 is vertically above the tag 220.

The tag of FIG. 4c includes various features, described above. In some examples some of these features may be omitted. The features may be combined in any suitable combination, depending on the desired properties. The features include: conductive coupling between the feed line and transmit antenna, the relative orientations of the receive and transmit antennas, the first stepped portion of the feedline, the second stepped portion of the feedline, the presence of a single ground pad. Any of these features may be used in the absence of the other features. Any two or more of these may be used together.

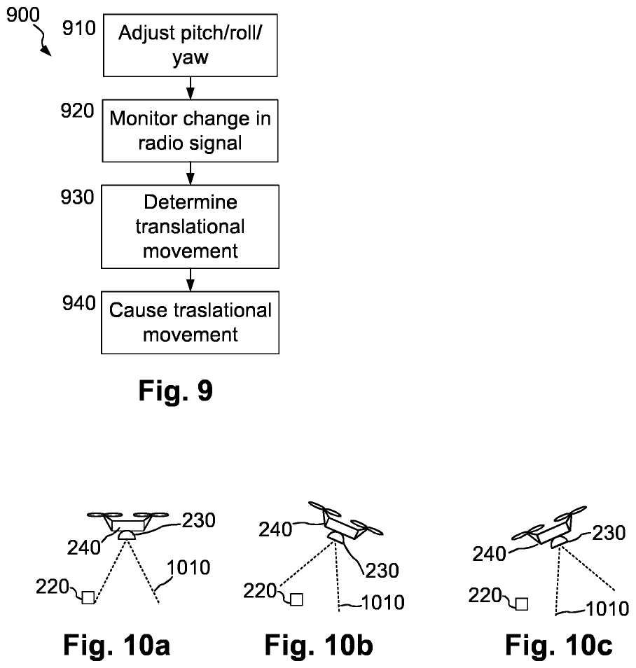

FIG. 9 illustrates a method 900 for controlling a UAV 240 according to some examples. A UAV 240 is controlled 910 to change its orientation (e.g. its pitch, roll, yaw, or a combination of these). A change in radio signal 225 received at the UAV 240 with the change in orientation (e.g. pitch, roll or yaw) is monitored 920. The radio signal 225 may be a radar signal, such as the signal of a resonant tag 220 in the system of FIG. 2a. A translational movement of the UAV 240 may be determined based on the monitored change. Translational movement of the UAV 240 may be caused based on the determination.

According to the method of FIG. 9, a direction from which the radar signal originates may be determined using movement of the UAV 240. In particular, a radar receiver 230 mounted on the UAV 240 may be stationary with respect to the UAV 240. For example, where a gimble or other mechanical means for moving or scanning the radar receiver 230 with respect to the UAV 240 is omitted. The radar receiver 230 may be mounted to the UAV 240 such that the radar receiver 230 is immoveable relative to the UAV 240.

FIG. 10a shows an example of a UAV 240 carrying a radar receiver 230 in the vicinity of tag 220. A region from which the receiver 230 may receive a signal from tag 220 is illustrated by lines 1010. As would be appreciated, the gain of the receiver may vary with direction. For example, the signal may be received more strongly if the signal is in the centre of lines 1010, more weakly in the region of the lines 1010 and more weakly still outside lines 1010.

In FIG. 10a, the signal from the tag 220 might not be received by the receiver 230, or might be received only weakly. In FIG. 10b, the roll of the UAV 240 has been adjusted, which has the effect of tilting the receiver 230. With this orientation of the UAV 240, the tag 220 lies closer to the centre of the lines 1010, and so the signal from the tag may be received more strongly at the receiver 230.

FIG. 10c shows the result of the UAV 240 rolling in the opposite direction to the roll in FIG. 10b. In this case the tag 220 is far outside the lines 1010. This may correspond to no signal, or only a very weak signal, being received from tag 220 at receiver 230. The signal received by the receiver 230 may be weaker in the arrangement of FIG. 10c than in FIG. 10a, and the signal received by the receiver 230 may be weaker in the arrangement of FIG. 10a than in FIG. 10b. Accordingly, the variation of the received signal strength may be used to determine that the tag 220 is located to the left of the UAV 240 (as viewed in FIGS. 10a to 10c).

FIGS. 10a to 10c show the arrangement when viewed towards a front or back of the UAV 240 and the roll of the UAV 240 is adjusted. As would be understood by the skilled person, the situation is analogous when the UAV 240 is viewed from the side and the pitch of the UAV 240 is adjusted.

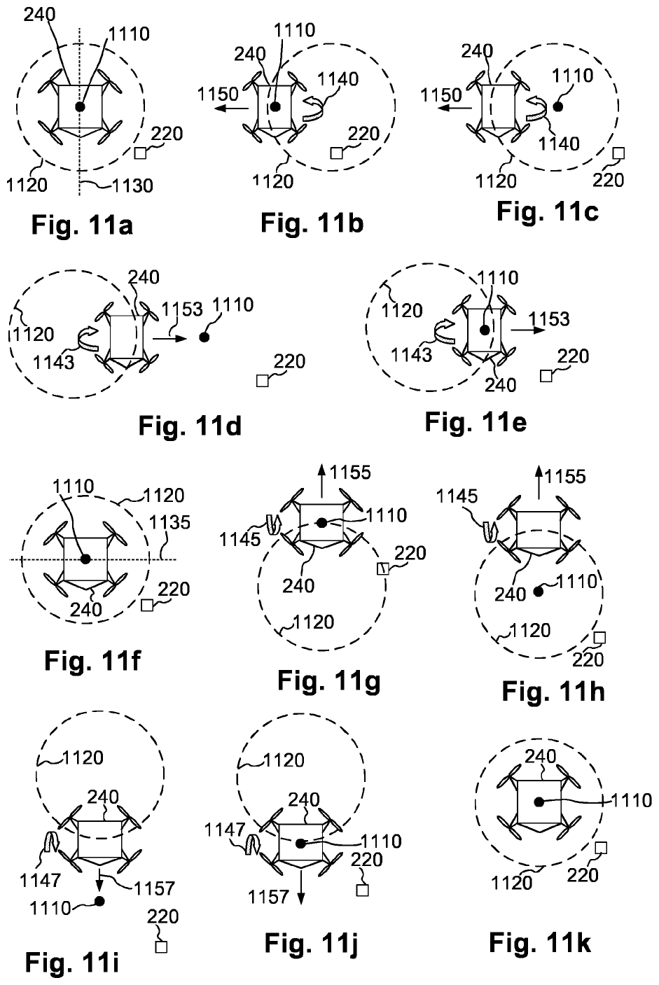

FIGS. 11a to 11k show an example of pitch and roll adjustments of a UAV 240 for detecting a radar source. FIG. 11a shows top view of a UAV 240. The UAV 240 may be placed in a search mode, for example, which causes the UAV 240 to manoeuvre to allow a direction to a tag 220 (radar source) to be determined. The UAV 240 is controlled to stop movement over a point 1110. Circle 1120 represents a region from which the receiver 230 may receive signals. For the purpose of this explanation, the receiver is assumed to detect signals within a cone projecting from the receiver 130 perpendicular to a bottom surface of the UAV 240. The circle 1110 may be considered to be the intersection of this cone with the ground. In the example of FIG. 11a, the UAV 240 is parallel with the ground (no pitch or roll). In this example, the tag 220 is assumed to be close to the ground. In this example, the tag 220 is assumed to be stationary with respect to point 1110. As the tag 220 is outside circle 1120, the signal from the tag is not received, or only weakly received at the receiver 130.

In FIG. 11b the UAV 240 is controlled to roll about an axis 1130 passing front-to-back through the UAV 240. The roll is illustrated by arrow 1140, and causes the right hand side (as viewed in FIG. 11b) of the UAV 240 to raise, and the left hand side to lower. This roll causes the detection cone of the receiver 130 to tilt, and move relative to the point 1110, as shown in FIG. 11b. This may result in the tag 220 being within circle 1120. Thus, the signal from the tag 220 may be detected more strongly than in the arrangement of FIG. 11a. For simplicity of illustration, a circle 1120 is used to illustrate the intersection of the cone with the ground in FIG. 11b, although the tilt of the UAV 240 would lead to deformation of the circle 1120.

The roll of the UAV 240 will result in a component of thrust in the horizontal direction, as shown by arrow 1150. This will cause the UAV to drift or move relative to the point 1110, as shown in FIG. 11c. This movement may have an effect of the strength of the received signal, as the UAV 240 moves relative to the tag 220.

In FIG. 11d, the roll of the UAV 240 is reversed, so it is in the opposite direction to the roll in FIG. 11b. The reversed roll is shown as arrow 1143. The roll may be equal and opposite in magnitude to the roll in FIG. 11a. As shown in FIG. 11d, the detection cone of the receiver 130 is tilted in the opposite direction to FIGS. 11b and 11c. This moves the detection cone 1120 further away from tag 220 and so will reduce any received signal.

The roll of the UAV 240 in FIG. 11d will induce a thrust 1135. The trust 1135 will be opposite the thrust 1150 of FIGS. 11b and 11c, and will tend to move the UAV 240 back towards point 1110. FIG. 11e shows the situation when the UAV 240 has returned to point 1110. The roll may then be removed, as in FIG. 11f, so that the UAV 240 is stationary about the starting point 1110.

As shown in FIG. 11g, a pitch of the UAV 240 may then be adjusted by rotating the UAV around a left-right axis 1135 of the UAV, as shown in FIG. 11g. The front of the UAV may be raised and the rear may be lowered. This change in pitch may move the circle 1120 relative to the point 1110. This change may result in a increase or decrease in the received signal from the tag 220. The tilt of the UAV gives rise to a horizontal thrust 1155, causing the UAV 240 to move backward relative to point 1110, as shown in FIG. 11h. The pitch may be reversed, such that the front of the UAV 240 is lower than the rear of the UAV 240, as shown in FIG. 11i. This reversed pitch is shown as arrow 1147. This change in pitch results in a movement of circle 1120 relative to the point 1110. This may result in a change in the received signal strength at the receiver 230. The pitch may be equal in magnitude to the pitch in FIG. 11g, but in the opposite direction. The pitch results in a horizontal component of thrust 1157 that is opposite the thrust 1155 of FIGS. 11g and 11h. This thrust 1157 will move the UAV back towards point 1110. The UAV may be returned to an un-pitched state above point 1110, as shown in FIG. 11k.

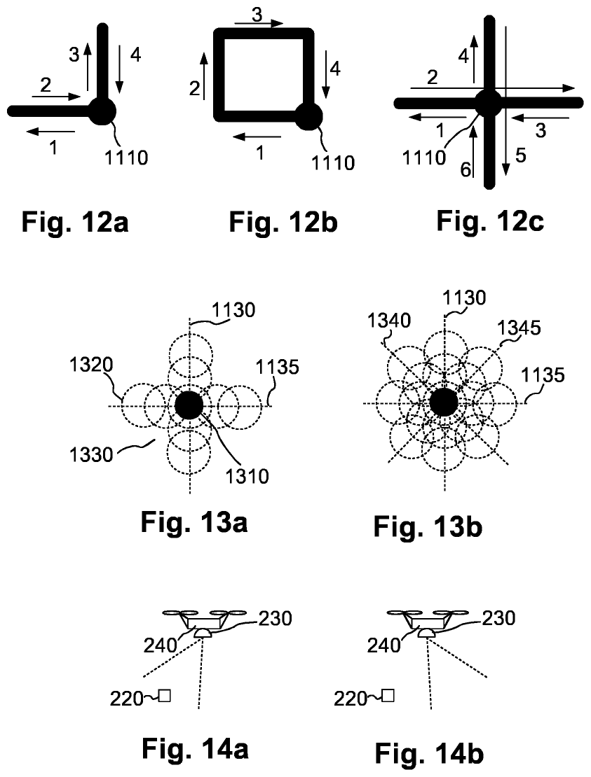

The Example in FIGS. 11a to 11k assume, for the sake of illustration, that the detection region of the detector 230 is a cone, but any suitable detection region may be used. Further, the movement pattern of the UAV 240 may be modified. In FIGS. 11a to 11k the UAV 240 may return to its starting point 1110 after rotating about a first axis and prior to rotating about a second axis; the corresponding path is illustrated in FIG. 12a, with numbered arrows showing the order of movement. This may simplify a comparison of received signal strength with different rotations, by removing or reducing variations due to horizontal movement of the UAV 240. However, in other examples, the UAV 240 may rotate about different axes before returning to its starting point 1110. For example, the UAV may roll, followed by a pitch, followed by a roll and then a pitch in the opposite directions. This may cause the UAV to fly along a square path, as shown in FIG. 12b. In some examples, the UAV may roll in a first direction, followed by a roll in the opposite direction for twice as long (or for twice the distance), followed by another roll in the first direction to arrive at the start point 1110. The UAV may then pitch in a second direction, followed by a pitch in the opposite direction for twice as long, followed by another pitch in the second direction to return to the start point 1110. This arrangement is symmetrical about the start point, as shown in FIG. 12c.

In the examples of FIGS. 10 to 12, the UAV 240 performs pitching and rolling in separate steps. However, in some examples the UAV 240 may pitch and roll at the same time.

In some examples, the detection zone of the receiver 130 may be narrow, such that coverage gaps exist between a pitch operation and a roll operation. FIG. 13a schematically shows an example of a coverage pattern when the UAV 240 performs a pitch and roll where the detection zone is narrow. For the purposes of this simplified example, translational movement of the UAV 240 is not considered. Point 1310 is the point directly below the UAV 240. Circles 1320 are indicative of a detection zone at various times during the pitch and roll operation, where the UAV 240 rolls in equal and opposite directions about roll axis 1130 and then rolls in equal and opposite directions about pitch axis 1135. As can be seen coverage gaps 1330 may be present between the detection zones. FIG. 13b shows an example in which, in addition to rotations about the roll axis 1130 and pitch axis 1135, the UAV is also rotated about axes 1340 and 1345, which lie between the roll 1130 and pitch 1135 axes. In the example of FIG. 13b, the UAV is rotated about four axes, but other possibilities may be used. For example, depending on a detection zone of the receiver 130. For example, the UAV 240 may be rotated around three different axes (all lying perpendicular to the yaw axis). In some examples the axes may be equally spaced from each other in the horizontal plane, but this is not a requirement.

A method of controlling a UAV may include causing the UAV to sequentially tilt about a plurality of axes, wherein the UAV carries a receiver for receiving a radar signal, the receiver having an associated detection zone that is tilted with the tilt of the UAV, and the tilting of the UAV is such that, for any neighbouring first and second axes of the plurality of axes, the detection zone of the UAV when tilted about the first axis partially overlaps the detection zone of the UAV when tilted about the second axis.

FIG. 14a shows an example of a UAV 240 having a detector 230 that has a detection zone that is not symmetrical about a yaw axis (i.e. a top-to-bottom axis) of the UAV 240. When a yaw of the UAV is adjusted (i.e. the UAV rotates about the yaw axis) the directions from which the receiver 230 receive strongly changes. FIG. 14b shows the arrangement when the UAV of FIG. 14a has been rotated through 180 degrees. The signal from the tag 220 will be received more strongly in the arrangement of FIG. 14a than in FIG. 14b.

In the examples of FIGS. 10 to 14, the received signal strength and the pitch, roll, yaw, etc. of the UAV 240 may be used to determine a direction from which the signal from the tag 220 is most strongly received. This may then indicate a direction in which the UAV 240 is to move in order to approach a point above the tag 220. Accordingly, a determined translational movement of the UAV may correspond to a horizontal movement of the UAV towards the direction of greatest strength of the received radio signal. The determined translational movement may correspond to a movement of the UAV in a direction towards a point above a source of the radio signal. The translational movement of the UAV may cause the UAV to fly above a source of the radio signal.

The UAV may carry a radio receiver 130 to receive the radio signal, and wherein the adjustment in pitch, roll or yaw causes a direction of maximum gain of the radio receiver to sweep a pattern. The pattern may approximate a cross pattern. In some examples, the pattern may approximate a pattern including a plurality of arms radiating from a point. In some examples the number of arms may be such that a detection zone associated with respective neighbouring arms overlap to provide a continuous detection zone.

In some examples, the control of the UAV 240 may be carried out by a computing device. The computing device may be carried by the UAV 240 or may be remote from, and in communication with, the UAV 240. A program for a computer may cause the processor to receive data describing an orientation of a UAV. The orientation may include a pitch, roll, yaw, or a combination of these. In some examples, the data may also include a location of the UAV 240. The program may further cause the processor to receive data describing a radar signal received by a receiver 130 mounted on the UAV 240. The program may further cause the processor to determine a change in the radar signal corresponding with a change in the orientation of the UAV; and to determine a direction of the radar signal based on the change in the radar signal and the corresponding change in the orientation. In some examples, the program may further cause the processor to control the UAV to move toward a point above the source.

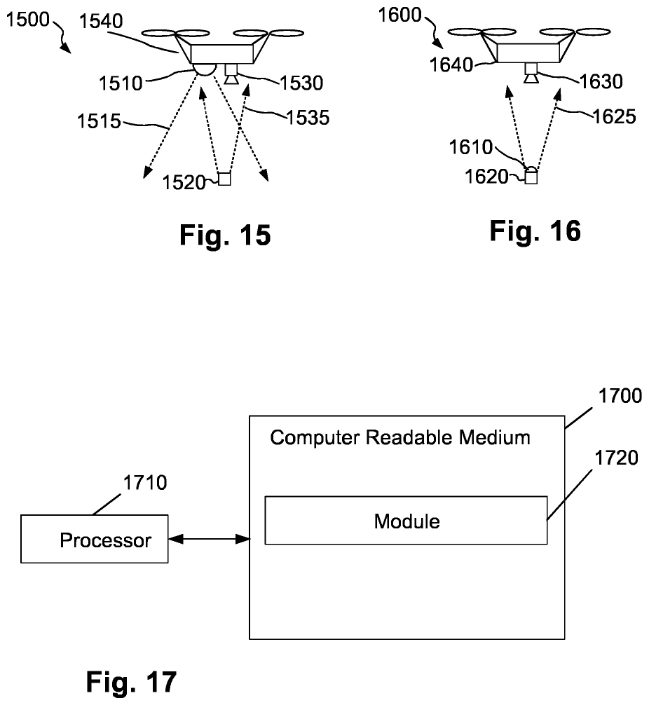

FIG. 15 shows an example of a system 1500 that includes a UAV 1540 and a tag 1520. In this example, the tag 1520 includes a retroreflective element, and may be referred to as a retroreflective tag. A retroreflective material reflects radiation (infrared radiation, in this case) back to its source with very little scattering, with this effect occurring for a wide range of incidence angles.

The UAV carries an infrared camera 1530. The infrared camera 1530 may be a digital camera, e.g. having a charge-coupled device (CCD) sensor or a complementary metal-oxide semiconductor (CMOS) sensor. The camera 1530 may be provided with an infrared filter to pass a range of infrared wavelengths and to block other wavelengths (such as other infrared wavelengths and visible light wavelengths). The camera 1530 may be mounted to provide view below the UAV 1540. In some examples the camera 1530 may be mounted to have a fixed orientation with respect to the UAV 1540. In some examples the camera 1530 may have a moveable orientation with respect to the UAV 1540, e.g. by being mounted on a gimbal.

The UAV also carries an infrared light source 1510. The light source 1510 may emit infrared radiation at a wavelength that can be detected by the camera 1530. For example, a range of wavelengths emitted by the infrared light source 1510 may include or overlap with a range of wavelengths that are passed by a filter on the camera 1530. The light source 1510 may include a plurality of infrared LEDs.

When infrared radiation 1515 emitted by the light source 1510 is incident on the tag 1520, the infrared radiation is reflected from tag 1520 back toward the light source 1510 and the reflected infrared radiation 1535 may be detected by the camera 1530. This may allow the location of the tag 1520 relative to the UAV 1540 to be determined.

In some examples, the camera may have a filter to block infrared radiation with a wavelength outside of a range of 900 nm to 1000 nm. The filter may block infrared radiation with a wavelength outside of a range of 920 nm to 960 nm. The filter may block infrared radiation with a wavelength outside of a range of 930 nm to 950 nm. The filter may be a 940 nm filter, to allow infrared radiation of 940 nm to pass.

Solar radiation at 940 nm is absorbed by water particles in the atmosphere, such that a large proportion of the light at this wavelength is absorbed in the atmosphere. As a result, the solar spectral irradiance at sea level is reduced in a range of wavelengths around 940 nm. The filter thus removes wavelengths that are the dominant components of sunlight at sea level. Accordingly, the amount of infrared radiation of solar origin (either directly incident or reflected) reaching the camera is significantly reduced by the filter. In contrast, infrared radiation 1515 from the light source 1510 that is reflected by the tag 1520 towards the camera 1530 is less strongly filtered. This may result in the tag 1520 appearing much brighter than its surroundings in an image captured by the camera 1530.

The tag 1520 may appear as a bright spot in the image captured by the camera 1530. A position of the bright spot (tag 1520) relative to the UAV 1540 may be determined. In some examples a direction from the UAV 1540 to the tag 1520 may be determined. In some examples, based on a determination of the tag 1530 location/direction, the UAV 1540 may be controlled to move toward a point directly above the tag 1520.

In some examples, the location of the tag may be determined by analysing an image captured by the camera 1530. The analysis may include identifying a brightest pixel in the image, or a brightest cluster of pixels in the image, for example.

In some examples, a tag detection section may receive input from the infra-red camera and identify a location of the retroreflective tag relative to the UAV based on the received input. The tag detection section may be carried by the UAV 1540 or may be separate from the UAV 1540, e.g. in a ground-based station. A controller may control the UAV to move towards a point above the retroreflective tag. The controller may be carried by the UAV 1540 or may be separate from the UAV 1540, e.g. in a ground-based station.

In some examples the infrared light source 1510 may have a spectrum with a peak at a wavelength between 900 nm and 1000 nm. In some examples the infrared light source 1510 may have a spectrum with a peak at about 940 nm.

In some examples, the UAV 1540 may be controlled to move toward, or remain at, a point directly above the tag 1520. The location of the UAV 1540 may be determined, e.g. using GPS, and the location of the tag 1540 may be approximated as the location of the UAV 1540.

In some examples, the location of the UAV 1540 may be determined (e.g. using GPS), an orientation of the UAV 1540 may be determined (e.g. using a magnetometer), and the location of the tag 1520 relative to the UAV 1540 may be determined based on an image captured by the camera 1530. The location of the tag 1520 may then be determined based on the location of the UAV 1540 and the relative location of the tag 1520. This may be implemented in software. In some examples the UAV 1540 may be controlled to follow the tag 1520, e.g. to maintain the tag within a field of view of the camera 1530.

The tag of FIG. 15 may be small and lightweight. For example, a retroreflective tag may have an area of 1.5 mm² to 3 mm², 2 mm² to 2.5 mm², or 2.5 mm² to 3 mm², for example (depending on target size). This is small and light enough to be carried by a bird or an insect (such as a bee, beetle or locust), etc. Larger retroreflective tags may be more easily detected, while smaller tags may be carried by smaller targets.

FIG. 16 shows a system 1600 that includes a UAV 1640 and a tag 1620. The UAV 1640 carries an infrared camera 1630. Tag 1620 has an infrared light source 1610.

Infrared light 1625 emitted by the infrared light source 1610 may be detected by the infrared camera 1630. The infrared light source 1610 may have a spectrum with a peak at a wavelength between 900 nm and 1000 nm. In some examples the infrared light source 1610 may have a spectrum with a peak at about 940 nm. In some examples the light source 1510 may be small and lightweight, and may include an infrared LED, for example. A small and lightweight power source, such as a button cell, may be provided to power the infrared LED. In some examples the LED may be pulsed (e.g. turned on and off at a predetermined frequency) to reduce the power consumption by the LED. Pulsing the LED may make the target easier to detect. Where multiple tags are used, different pulse patterns and/or colours may be used to differentiate the tags. The frequency and duty cycle of the LED may be selected depending on an intended application, such as an expected speed range of the target to which the tag 1620 is to be attached.

The camera 1630 may be similar to the camera 1530 described in relation to FIG. 15. The camera 1630 may have a filter, similar to the filter described in relation to FIG. 15. A range of wavelengths emitted by the infrared light source 1610 may include or overlap with a range of wavelengths that are passed by a filter on the camera 1630. The camera 1630 may be mounted to provide view below the UAV 1640. In some examples the camera 1630 may be mounted to have a fixed orientation with respect to the UAV 1640. In some examples the camera 1630 may have a moveable orientation with respect to the UAV 1640, e.g. by being mounted on a gimbal.

The arrangement of FIG. 16 may operate in a similar manner to FIG. 15. The location or direction of the tag 1620 relative to the UAV 1640 may be determined based on an image captured by camera 1630. The tag 1520 may appear as a bright spot in the image, and may be detected by image processing (e.g. by detecting a brightest pixel or group of pixels). The UAV 1640 may be controlled based on the determined location or direction. For example the UAV 1640 may be controlled to move toward a point above the tag 1620.

The system 1600 may include a tag detection section to receive input from the infra-red camera and identify a location of the tag relative to the UAV based on the received input. The system may also include a controller to control the UAV to move towards a point above the tag.

The infrared light source may have a spectrum with a peak at a wavelength between 900 nm and 1000 nm.

In some examples, a radar tag (e.g. as described in relation to FIGS. 2 to 14) may include a retroreflective portion (e.g. as in FIG. 15) or an infrared light source (e.g. as in FIG. 16). An associated UAV may include a receiver 130 to receive the radar signal from the tag, as well as a camera 1530, 1630 (similar to FIGS. 15 and 16). Where the tag has a retroreflective portion the UAV may also include an infrared light source 1510, as in FIG. 15.

According to this example, the UAV may use a combination of radar and infrared signals to track the tag. For example, the radar measurement may provide a coarse location for the tag and a captured infrared image may provide a more accurate location for the tag.

In some examples, a radar-based location (determining the tag based on radar signal strength) may have an accuracy of around 1 meter to 3 meters. The location of the tag may be pinpointed in the infrared camera's field of view, providing a more accurate location for the tag. For example, in some examples, the infrared camera may be used to determine the location with an accuracy of around 1 meter, or less. The UAV may be controlled to move to a position directly above the tag by pinpointing the tag in the camera's field of view. In some examples, the location of the tag 220 may be determined more accurately based on the location of one or more other objects visible to the infrared camera, and the location of the tag 220 relative to the other object(s). where the other object(s) have known locations. In some examples a camera operating at visible wavelengths may be used in combination with the infrared camera, with the other object(s) being identified based on the visible light camera and the location of the tag 220 relative to the object(s) based on the infrared camera. In some examples the other objects may include one or more of a natural object (e.g. a plant), or a marker that has been placed for the purposes of location determination. The marker may be an object that is detectable to at least the infrared camera or the visible light camera. A marker may include a light source, for example. A light source of a marker may pulse with a pattern (e.g. a pattern of long and short pulses) to assist in identifying the marker or differentiating markers.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or machine readable storage such as, for example, DVD, memory stick or solid state medium. It will be appreciated that the storage devices and storage media are embodiments of non-transitory machine-readable storage that are suitable for storing a program or programs comprising instructions that, when executed, implement embodiments described herein. Accordingly, embodiments provide machine executable code for implementing a system, device or method as described herein or as claimed herein and machine readable storage storing such code. Still further, such programs or code may be conveyed electronically via any medium such as a communication signal carried over a wired or wireless connection and embodiments suitably encompass the same.

FIG. 17 shows an example of a computer-readable storage medium 1700 coupled to at least one processor 1710. The computer-readable medium 1700 can be any medium that can contain, store, or maintain programs and data for use by or in connection with an instruction execution system.

In FIG. 17, the computer-readable storage medium comprises module 1720 (e.g. program code). The module 1720 may cause the processor 1720 to perform a method corresponding to the example shown in FIG. 9. In other examples, the module 1720 may cause the processor 1710 to perform other operations of the examples described herein. For example, the module 1720 may control operation of a UAV in accordance with examples described herein. In addition, or alternatively, the module 1720 may receive information from a radar receiver, an infrared camera, or both, and may process the information to determine a relative location or direction of a tag. In some examples, the module may control a UAV in a search mode, as described in relation to FIGS. 9 to 14.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The reader's attention is directed to all papers and documents which are filed concurrently with or previous to this specification in connection with this application and which are open to public inspection with this specification, and the contents of all such papers and documents are incorporated herein by reference.

The following paragraphs set out particular examples according to the preceding disclosure.

1. A system comprising: a passive resonator tag to receive radio waves at a first frequency and emit radio waves at a second frequency, the second frequency being a harmonic of the first frequency; an unmanned aerial vehicle, UAV; a radio receiver to be carried by the UAV, the radio receiver to receive radio waves at the second frequency emitted by the passive resonator tag, wherein the passive resonator tag comprises a transmit antenna lying in a first plane, and the transmit antenna is arranged to have a maximum gain in a direction within 45 degrees of a direction perpendicular to the first plane.

2. The system of paragraph 1, further comprising: a tag detector to determine a direction of the tag from the UAV based on the radio waves received by the radio receiver; a controller to control the UAV to move based on the determined direction.

3. The system of paragraph 2, wherein the controller is arranged to cause the UAV to change its orientation, such that a direction of maximum gain of the radio receiver changes; and the tag detector is to determine the direction based on a variation in the received radio waves with orientation of the UAV.

4. The system of paragraph 2 or 3, wherein the controller is to control the UAV to move toward a point above the tag.

5. The system of any one of paragraphs 1 to 4, wherein the tag is to be attached to, and carried by, a moving target, an insect, a bee, a beetle, a locust, or a bird.

6. The system of any one of paragraphs 1 to 5, wherein the passive resonator tag includes a retroreflective portion, and the UAV carries an infrared camera and an infrared light source.

7. The system of paragraph 6, wherein the camera includes a filter to block infrared radiation with a wavelength outside of a range of 900 nm to 1000 nm.

8. A passive transponder comprising: a (metamaterial) receive antenna to receive a signal at a first frequency; a (metamaterial) transmit antenna to transmit a signal at a second frequency, the second frequency being a harmonic of the first frequency, the transmit antenna lying in a first plane, wherein: the transmit antenna has a maximum gain in a direction within 45 degrees of a direction perpendicular to the first plane.

9. The passive transponder of paragraph 8, further comprising: a feed line coupled to each of the receive antenna and the transmit antenna, the feed line including a mixer to generate the signal at the second frequency, wherein the feed line is conductively coupled to the transmit antenna.

10. A passive transponder comprising: a (metamaterial) receive antenna to receive a signal at a first frequency; a (metamaterial) transmit antenna to transmit a signal at a second frequency, the second frequency being a harmonic of the first frequency, the transmit antenna lying in a first plane, a feed line coupled to each of the receive antenna and the transmit antenna, the feed line including a mixer to generate the signal at the second frequency, wherein the feed line is conductively coupled to the transmit antenna.

11. The passive transponder of paragraph 9 or 10, wherein the feed line includes a first stepped edge such that, at the second frequency, capacitive coupling between the feed line and transmit antenna dominates conductive coupling between the feed line and transmit antenna.

12. The passive transponder of paragraph 10 or 11, wherein the feed line includes a second stepped edge such that the feedline acts as a bandpass filter centred at the second frequency.

13. The passive transponder of any one of paragraphs 8 to 12, further comprising: a ground pad connected to a ground plane, wherein the ground pad is conductively connected to the receive antenna and the transmit antenna.

14. The passive transponder of any one of paragraphs 8 to 13, wherein: the receive antenna comprises two meta-atoms, each meta-atom including a plate portion connected to a respective leg portion, the transmit antenna comprises two meta-atoms, each meta-atom including a plate portion connected to a respective leg portion, wherein each plate portion is wider than the respective leg portion, and the leg portions extend in the same direction away from the respective plate portions.

15. The passive transponder of any one of paragraphs 8 to 14, further comprising a retroreflective patch or an infrared light source.

16. A method for controlling an aerial vehicle, UAV, comprising: causing the UAV to adjust its pitch, roll, yaw, or a combination; monitoring a change in radio signal received at the UAV with the change in pitch, roll or yaw; determining a translational movement of the UAV based on the monitored change; and causing translational movement of the UAV based on the determination.

17. The method of paragraph 16, wherein the determined translational movement corresponds to a horizontal movement of the UAV towards the direction of greatest strength of the received radio signal.

18. The method of paragraph 16, wherein the determined translational movement corresponds to a movement of the UAV in a direction towards a point above a source of the radio signal.

19. The method of any one of paragraphs 16 to 18, wherein the causing translational movement of the UAV is to cause the UAV to fly above a source of the radio signal.

20. The method of any one of paragraphs 16 to 19, wherein the UAV carries a radio receiver to receive the radio signal, and wherein the adjustment in pitch, roll or yaw causes a direction of maximum gain of the radio receiver to sweep a pattern.

21. A program for a computer, the program to, when executed by a processor, cause the processor to: receive data describing an orientation of an unmanned aerial vehicle (UAV); receive data describing a radar signal received by a receiver mounted on the UAV; determine a change in the radar signal corresponding with a change in the orientation of the UAV; and determine a direction of the radar signal based on the change in the radar signal and the corresponding change in the orientation.

22. A method of controlling an unmanned aerial vehicle includes: causing the UAV to sequentially tilt about a plurality of axes, wherein the UAV carries a receiver for receiving a radar signal, the receiver having an associated detection zone that is tilted with the tilt of the UAV, and the tilting of the UAV is such that, for any neighbouring first and second axes of the plurality of axes, the detection zone of the UAV when tilted about the first axis partially overlaps the detection zone of the UAV when tilted about the second axis.

23. A system comprising: an unmanned aerial vehicle, UAV; an infrared camera carried by the UAV; an infrared light source carried by the UAV; a retroreflective tag. The retroreflective tag may be carried by an object to be tracked using the UAV.

24. The system of paragraph 23, further comprising: a tag detection section to receive input from the infra-red camera and identify a location of the retroreflective tag relative to the UAV based on the received input; and a controller to control the UAV to move towards a point above the retroreflective tag.

25. The system of paragraph 23 or 24, wherein the infrared camera has a filter to block infrared radiation with a wavelength outside of a range of 900 nm to 1000 nm. The filter may block infrared radiation with a wavelength outside of a range of 920 nm to 960 nm. The filter to block infrared radiation with a wavelength outside of a range of 930 nm to 950 nm. The filter may be a 940 nm filter, to allow infrared radiation of 940 nm to pass.

26. The system of any one of paragraphs 23 to 25, wherein the infrared light source has a spectrum with a peak at a wavelength between 900 nm and 1000 nm.

27. A system comprising: an unmanned aerial vehicle, UAV; an infrared camera carried by the UAV; a tag having an infrared light source.

28. The system of paragraph 27, further comprising: a tag detection section to receive input from the infra-red camera and identify a location of the tag relative to the UAV based on the received input; and a controller to control the UAV to move towards a point above the tag.

29. The system of paragraph 27 or 28, wherein the infrared light source has a spectrum with a peak at a wavelength between 900 nm and 1000 nm.

1A. A method for controlling an aerial vehicle, UAV, comprising causing the UAV to adjust its orientation; monitoring a change in radio signal received at the UAV with the change in orientation; determining a translational movement of the UAV based on the monitored change; and causing translational movement of the UAV based on the determination.

2A. The method of paragraph 1A, wherein causing the UAV to adjust its orientation includes causing the UAV to adjust its pitch, roll, yaw, or a combination.

3A. The method of paragraph 1A or paragraph 2A, wherein the determined translational movement corresponds to a horizontal movement of the UAV towards the direction of greatest strength of the received radio signal.

4A. The method of paragraph 1A or paragraph 2A, wherein the determined translational movement corresponds to a movement of the UAV in a direction towards a point above a source of the radio signal.

5A. The method of any one of paragraphs 1A to 4A, wherein the causing translational movement of the UAV is to cause the UAV to fly above a source of the radio signal.

6A. The method of any one of paragraphs 1A to 5A, wherein the UAV carries a radio receiver to receive the radio signal, and wherein the adjustment in pitch, roll or yaw causes a direction of maximum gain of the radio receiver to sweep a pattern.

7A. The method of any one of paragraphs 1A to 6A, wherein causing the UAV to adjust its orientation includes causing the UAV to sequentially tilt about a plurality of axes, the UAV carries a receiver for receiving the radio signal, the receiver having an associated detection zone that is tilted with the tilt of the UAV, and the tilting of the UAV is such that, for any neighbouring first and second axes of the plurality of axes, the detection zone of the UAV when tilted about the first axis partially overlaps the detection zone of the UAV when tilted about the second axis.

8A. A system comprising an unmanned aerial vehicle, UAV, controller to control a UAV according to the method of any one of paragraphs 1A to 6A; the UAV; a passive resonator tag to receive radio waves at a first frequency and emit radio waves at a second frequency, the second frequency being a harmonic of the first frequency; a radio receiver to be carried by the UAV, the radio receiver to receive radio waves at the second frequency emitted by the passive resonator tag.

9A. The system of paragraph 8A, wherein the controller is to control the UAV to move toward a point above the tag.

10A. The system of paragraph 8A or paragraph 9A, wherein the passive resonator tag comprises a transmit antenna lying in a first plane, and the transmit antenna is arranged to have a maximum gain in a direction within 45 degrees of a direction perpendicular to the first plane.

11A. The system of paragraph 10A, wherein the passive resonator tag comprises a receive antenna to receive the signal at the first frequency; and a feed line coupled to each of the receive antenna and the transmit antenna, the feed line including a mixer to generate the signal at the second frequency, wherein the feed line is conductively coupled to the transmit antenna.

12A. The system of paragraph 11A, wherein the feed line includes a first stepped edge such that, at the second frequency, capacitive coupling between the feed line and transmit antenna dominates conductive coupling between the feed line and transmit antenna.

13A. The system of paragraph 11A or paragraph 12A, wherein the feed line includes a second stepped edge such that the feed line acts as a bandpass filter centred at the second frequency.

14A. The system of any one of paragraphs 8A to 13A, wherein the passive resonator tag comprises a ground pad connected to a ground plane, wherein the ground pad is conductively connected to the receive antenna and the transmit antenna.

15A. The system of any one of paragraphs 8A to 14A, wherein the receive antenna comprises two plate portions, each connected to a respective leg portion, the transmit antenna comprises two plate portions, each connected to a respective leg portion, wherein each plate portion is wider than the respective leg portion, and the leg portions extend in the same direction away from the respective plate portions.

16A. The system of any one of paragraphs 7A to 15A, wherein the tag is to be attached to, and carried by, a moving target, an insect, a bee, a beetle, a locust, or a bird.

17A. The system of any one of paragraphs 7A to 16A, wherein the passive resonator tag includes a retroreflective portion, and the UAV carries an infrared camera and an infrared light source.

18A. The system of paragraph 17A, wherein the camera includes a filter to block

infrared radiation with a wavelength outside of a range of 900 nm to 1000 nm.

19A. A program for a computer, the program comprising instructions that when executed by a computing device, cause the computing device to carry out the method of any one of paragraphs 1A to 7A.

20A. A non-transitory computer-readable storage medium, the computer-readable

storage medium including instructions that when executed by a computing device, cause the computing device to carry out the method of any one of paragraphs 1A to 7A.

21A. A computing apparatus comprising a processor; and a memory storing instructions that, when executed by the processor, configure the apparatus to carry out the method of any one of paragraphs 1A to 7A.

1-21. (canceled)

22. A passive resonator tag comprising:
a receive antenna to receive radio waves at a first frequency;
a transmit antenna to emit radio waves at a second frequency, the second frequency being a harmonic of the first frequency; and
a retroreflective portion.

23. The passive resonator tag of claim 22, wherein the transmit antenna lies in a first plane, and the transmit antenna is arranged to have a maximum gain in a direction within 45 degrees of a direction perpendicular to the first plane.

24. The passive resonator tag of claim 22, wherein the passive resonator tag comprises:
a feed line coupled to each of the receive antenna and the transmit antenna, the feed line including a mixer to generate the signal at the second frequency, wherein
the feed line is conductively coupled to the transmit antenna.

25. The passive resonator tag of claim 24, wherein the feed line includes a first stepped edge such that, at the second frequency, capacitive coupling between the feed line and transmit antenna dominates conductive coupling between the feed line and transmit antenna.

26. The passive resonator tag of claim 24, wherein the feed line includes a second stepped edge such that the feed line acts as a bandpass filter centred at the second frequency.

27. The passive resonator tag of claim 22, wherein the passive resonator tag comprises a ground pad connected to a ground plane, wherein the ground pad is conductively connected to the receive antenna and the transmit antenna.

28. The passive resonator tag of claim 22, wherein:
the receive antenna comprises two plate portions, each connected to a respective leg portion,
the transmit antenna comprises two plate portions, each connected to a respective leg portion, wherein
each plate portion is wider than the respective leg portion, and
the leg portions extend in the same direction away from the respective plate portions.

29. The passive resonator tag of claim 22, wherein the tag is to be attached to, and carried by, a moving target, an insect, a bee, a beetle, a locust, or a bird.

30. A system comprising:
the passive resonator tag comprising:
a receive antenna to receive radio waves at a first frequency;
a transmit antenna to emit radio waves at a second frequency, the second frequency being a harmonic of the first frequency; and
a retroreflective portion;
an unmanned aerial vehicle, UAV;
a UAV, controller to control the UAV;
a radio receiver to be carried by the UAV, the radio receiver to receive radio waves at the second frequency emitted by the passive resonator tag;
an infrared camera to be carried by the UAV; and
an infrared light source to be carried by the UAV.

31. The system of claim 30, wherein the controller is to control the UAV to move toward a point above the tag.

32. The system of claim 30, wherein the infrared camera includes a filter to block infrared radiation with a wavelength outside of a range of 900 nm to 1000 nm.

33. A method for tracking a passive resonator tag, comprising:
obtaining radar and infrared signals from the passive resonator tag; and
tracking the passive resonator tag using a combination of the radar and infrared signals.

34. The method of claim 33, comprising:
obtaining a coarse location of the passive resonator tag using the radar signal; and
obtaining a more accurate location of the passive resonator tag using the infrared signal.

35. The method of claim 33, wherein the radar signal is received at an unmanned aerial vehicle, UAV, and the method comprises:
causing the UAV to adjust its orientation;
monitoring a change in radar signal with the change in orientation;
determining a translational movement of the UAV based on the monitored change; and
causing translational movement of the UAV based on the determination.

36. The method of claim 35, wherein causing the UAV to adjust its orientation includes causing the UAV to adjust its pitch, roll, yaw, or a combination.

37. The method of claim 35, wherein the determined translational movement corresponds to a horizontal movement of the UAV towards the direction of greatest strength of the received radio signal.

38. The method of claim 35, wherein the determined translational movement corresponds to a movement of the UAV in a direction towards a point above a source of the radio signal.

39. The method of claim 35, wherein the causing translational movement of the UAV is to cause the UAV to fly above a source of the radio signal.

40. A non-transitory computer-readable storage medium, the computer-readable storage medium including instructions that when executed by a computing device, cause the computing device to carry out the method of claim 35.

41. A computing apparatus comprising:
a processor; and
a memory storing instructions that, when executed by the processor, configure the apparatus to carry out the method of claim 35.
